(19) United States
(12) Patent Application Publication
(10) Pub. No.: US 2022/0070615 A1
(43) Pub. Date: Mar. 3, 2022

(54) METHODS, SYSTEMS, APPARATUSES, AND DEVICES FOR FACILITATING PROVISIONING OF LOCATION-BASED INFORMATION TO A USER DEVICE

(71) Applicant: Brazen Technologies, LLC, White, GA (US)

(72) Inventor: Stephen Randall Bentley, White, GA (US)

(21) Appl. No.: 17/458,058

(22) Filed: Aug. 26, 2021

Related U.S. Application Data
(60) Provisional application No. 63/070,612, filed on Aug. 26, 2020.

(51) Int. Cl. H04W 4/02; G06F 16/22; G06F 16/9537

(52) U.S. Cl. CPC H04W 4/023; G06Q 10/109; G06F 16/9537; G06F 16/22

(57) ABSTRACT

A method and system for facilitating provisioning of location-based information to a user device is provided. The method may include a step of receiving, using a communication device, one or more beacon identifier from a user device. Further, the method may include a step of retrieving one or more digital content based on the one or more beacon identifier. Further, the method may include a step of transmitting, the one or more digital content to the user device. Further, the method may include a step of storing two or more digital content corresponding to two or more locations.

The current application claims a priority to the U.S. Provisional Patent application Ser. No. 63/040,612 filed on Aug. 26, 2020.

### TECHNICAL FIELD

Generally, the present disclosure relates to the field of data processing. More specifically, the present disclosure relates to methods, systems, apparatuses, and devices for facilitating provisioning of location-based information to a user device.

### BACKGROUND

The field of data processing is technologically important to several industries, business organizations, and/or individuals.

Listing a home, that is putting a home on the market to be sold, is a very inefficient process. The selling (or listing) agent has to often meet in person with a number of potential buyers (along with their agents known as the ‘Buyer's Agent’) in order to show a property. This entails driving to the home, making arrangements to meet the other parties, waiting around to answer questions, etc. One of the primary reasons for doing this is to ensure that the unique characteristics of the home are clearly communicated to the prospect. In the age of social distancing, these meetings are not only inefficient but also pose potential health risks to all parties concerned.

Therefore, there is a need for methods, systems, apparatuses, and devices for facilitating provisioning of location-based information to a user device that may overcome one or more of the above-mentioned problems and/or limitations.

### BRIEF SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for facilitating provisioning of location-based information to a user device, in accordance with some embodiments. The method may include a step of receiving, using a communication device, one or more beacon identifier from a user device. Further, the method may include a step of retrieving, using a processing device, one or more digital content based on the one or more beacon identifier. Further, the method may include a step of transmitting, using the communication device, the one or more digital content to the user device. Further, the method may include a step of storing, using a storage device, two or more digital content corresponding to two or more locations.

Further disclosed herein is a system for facilitating provisioning of location-based information to a user device, in accordance with some embodiments. The system may include a communication device, a storage device, and a processing device. Further, the communication device may be configured for performing a step of receiving one or more beacon identifier from the user device. Further, the communication device may be configured for performing a step of transmitting one or more digital content to the user device. Further, the storage device may be configured for performing a step of storing two or more digital content corresponding to two or more locations. The processing device may be communicatively coupled to the communication device and the storage device. Further, the processing device may be configured for performing a step of retrieving the one or more digital content based on the one or more beacon identifier.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates a system for facilitating showing real estate based on device proximity using Bluetooth, according to some embodiments.

FIG. 2 is a schematic of a system for showing real estate based on device proximity using Bluetooth, according to some embodiments.

FIG. 3 is a flow diagram of a method for showing real estate based on device proximity using Bluetooth, according to some embodiments.

FIG. 4 is a continuation flowchart of FIG. 3.

FIG. 5 is an illustration of an online platform consistent with various embodiments of the present disclosure.

FIG. 6 is a block diagram of a computing device for implementing the methods disclosed herein, in accordance with some embodiments.

FIG. 7 is a flow chart of a method for facilitating provisioning of location-based information to a user device, in accordance with some embodiments.

FIG. 8 is a flow chart of a method for facilitating provisioning of location-based information to a user device in which the method may include transmitting an indication of availability of a proximity based real estate showing to the user device, in accordance with some embodiments.

FIG. 9 is a flow chart of a method for facilitating provisioning of location-based information to a user device in which the method may include transmitting an indication of availability of the proximity based real estate showing to the user device, in accordance with some embodiments.

FIG. 10 is a flow chart of a method for facilitating provisioning of location-based information to a user device in which the method may include transmitting the resume time marker to the user device based on the receiving of the first beacon identifier at the third time instant, in accordance with some embodiments.

FIG. 11 is a flow chart of a method for facilitating provisioning of location-based information to a user device in which the method may include identifying the at least one beacon identifier based on the analyzing, in accordance with some embodiments.

FIG. 12 is a flow chart of a method for facilitating provisioning of location-based information to a user device in which the method may include determining an orientation of the user device in relation to the two or more beacons, in accordance with some embodiments.

FIG. 13 is a flow chart of a method for facilitating provisioning of location-based information to a user device in which the method may include retrieving a modified version of the one or more digital content based on the comparing, in accordance with some embodiments.

FIG. 14 is a block diagram of a system for facilitating provisioning of location-based information to a user device, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of facilitating provisioning of location-based information to a user device, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, physical state and/or physiological state and/or psychological state of the user, and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), and a biometric sensor (e.g. a fingerprint sensor).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The preset disclosure describes methods, systems, apparatuses, and devices for facilitating provisioning of location-based information to a user device. Further, the disclosed system may be configured for facilitating performing proximity-based property showing using beacons. Further, the disclosed system may be configured for facilitating presenting (or showing) real estate based on device proximity using Bluetooth™.

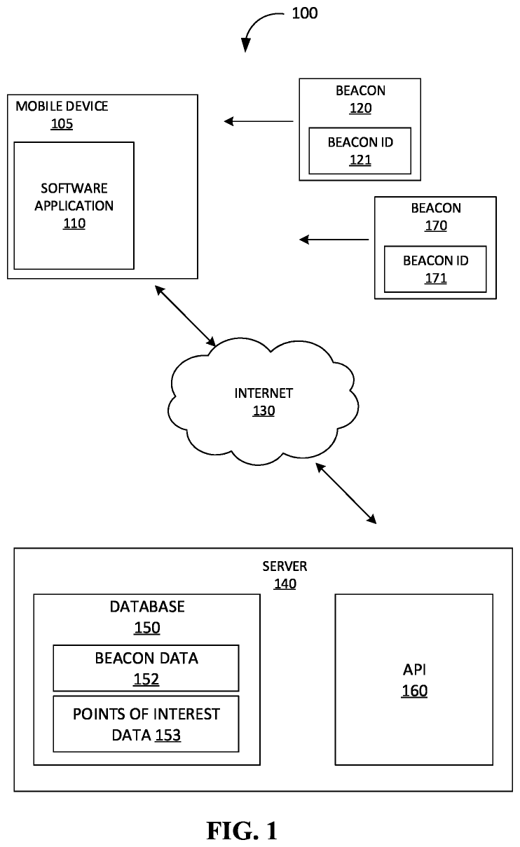

FIG. 1 illustrates a system 100 for facilitating showing real estate based on device proximity using Bluetooth, according to some embodiments. Further, the system 100 includes a mobile device 105, a server 140, and beacons (120 and 170). Further, the mobile device 105 includes software application 110, with communicates to the server 140 by way of the internet network 130. Further, the server 140 includes a database 150, which houses beacon data 152 (or beacon database) for the beacons (120 and 170) and points of interest (or Points of Interest database) 153. The system 100 may include an application programming interface (API) 160 which handles the information requests between the software application 110 and the database 150.

Furthermore, the system 100 may be used to provide a user (not shown) in possession of the mobile device 105 with a proximity-based property showing experience. In one implementation, the proximity-based property showing experience may include displaying the point of interest information (or Points of Interest database) 153 to the user in possession of the mobile device 105, where the point of interest information 153 is pre-generated and loaded within the software application 110. In such an implementation, the point of interest information 153 may include, but is not limited to, textual descriptions, text-to-speech descriptions, pre-recorded audio, or pre-recorded video.

Furthermore, the system 100 includes three separate devices in communication with one another, namely, the mobile device 105, the server 140, and the two beacons (120 and, 170). Each of the devices of the system 100 may include a personal computer, a mobile phone, a tablet, a Bluetooth beacon, or any other device capable of communicating with other devices using any wired or wireless technology. For example, in one implementation, the mobile device 105 includes a mobile phone or tablet computer, while each of the beacons (120 and 170) includes a Bluetooth beacon, or beacon using any other wireless technology. In such an implementation, the beacons (120 and 170) may transmit data to the mobile device 105 using a wireless technology.

In an embodiment, the system 100 may include any number of mobile devices, servers, and beacons in communication with one another. For example, in other implementations, the mobile device 105 may be in communication with a dozen beacons located throughout a home. In such an implementation, each of the beacons (120 and 170) may be communicating with the mobile device 105 using Bluetooth specifications.

Further, the mobile device 105 includes the software application 110. Further, the mobile device 105 utilizes the software application 110 to give users of the mobile device 105 proximity-based property showing experiences. As such, the software application 110 may include source code launched by a user of the mobile device 105, that is used to provide users with the proximity-based property showing experiences. Furthermore, the software application 110 may be downloaded and installed by a user of the mobile device 105. For example, and as discussed above where the beacons (120 and 170) include Bluetooth beacons, the beacon 120 may be transmitting advertisements at given intervals that include a beacon ID 121. Further, the beacon 170 may be transmitting at given intervals that include a beacon ID 171. In such an example, the mobile device 105 may receive one of the advertisements including the beacon ID 121 when a user in possession of the mobile device 105 gets within range of the beacon 120.

Further, the software application 110 communicates to the server 140 which includes a beacon database 152. Further, the beacon database 152 may include a database of stored information about each of the beacons that are utilized for the proximity-based property showing experiences, such as the beacons (120 and 170). Further, the beacon database 152 includes beacon identifiers, beacon locations, and other beacon information. For example, a user in possession of the mobile device 105 may be using the mobile device 105 to generate a proximity-based property showing experience for a given home. In this example, the user may first walk into the dining room and receive the beacon ID 121 transmitted from the beacon 120. After receiving the beacon ID 121 from the beacon 120, the mobile device 105 may execute the software application 110 to determine the beacon 120 transmitted the beacon ID 121, and determine that the beacon 120 is associated with a particular point of interest in the home, which is contained in the Points of Interest database (or data) 153. Further, the mobile device 105 may then execute the software application 110 to present content relative to that point of interest.

Further, the system 100 includes the server 140. Further, the mobile device 105 may utilize the server 140 to retrieve points of interest information for the beacons (120 and 170) contained in the present location. This information will be retrieved over the internet 130 using the API 160 on the server 140.

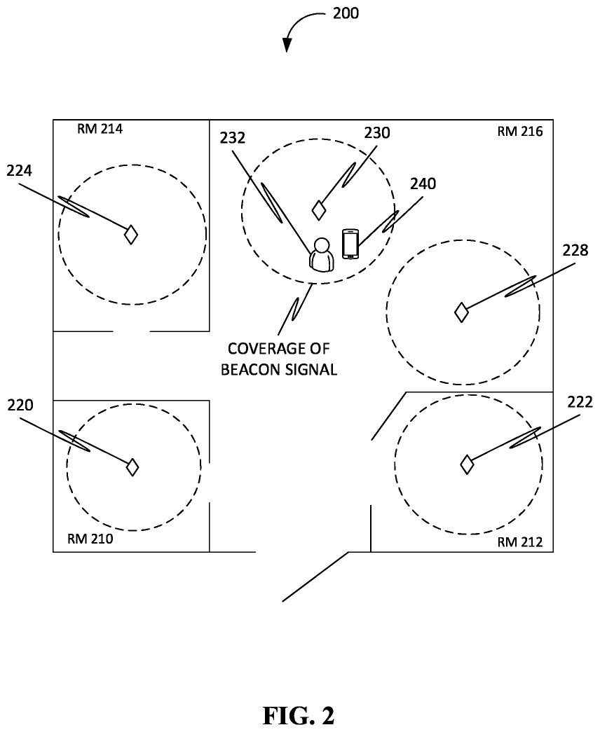

FIG. 2 is a schematic of a system 200 for facilitating showing real estate based on device proximity using Bluetooth, according to some embodiments. Further, the system 200 includes house, which includes rooms 210-216. Further, the house may include beacons 220-230 located within the house. Furthermore, a user 232 holding a mobile device 240 is also located within the house. Further, the multiple beacons 220-230 may be in the same room. For example, the room 216 could be a large open-concept area, with multiple beacons 220-230 placed on either side of the room 216.

Further, the mobile device 240 and the beacons 220-230 correspond respectively to the mobile device 105 and the beacons (120 and 170) described in FIG. 1. Furthermore, the software application 110 (as shown in FIG. 1) may be assumed to be running on the mobile device 240.

Further, the user 232 in possession of the mobile device 240 is using the software application 110 to enjoy a proximity-based property showing. In order to create the experience, each of the beacons 220-230 may be associated with a different point of interest. The user 232 in possession of the mobile device 240 walks into the rooms 210-216 (or different rooms) throughout the house to receive information on each point of interest. Further, the user 232 first walks into the room 216, which includes the beacon 228. In response to the user 232 walking into the room 216 and getting within range of the beacon 228, the mobile device 240 receives a unique beacon identifier from the beacon 228. After receiving the identifier, the software application (not shown) running on the mobile device 240 uses the beacon identifier to retrieve the point of interest information associated with that beacon. The information is then presented on the mobile device 240.

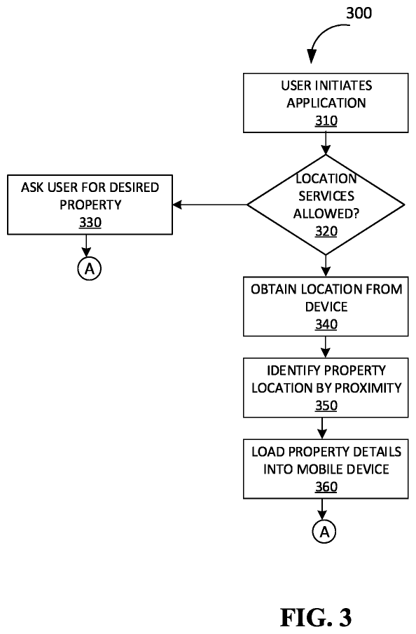

FIG. 3 is a flow diagram of a method 300 for showing real estate based on device proximity using Bluetooth according to some embodiments. Further, at 310, the method 300 includes a user with a mobile device 105 (such as the mobile device 240), starting the software application 110.

Further, at 320, the method 300 may include continuing with determining if the user has granted the software application 110 with permission to determine the geographic location of mobile device 105. Based on this determination, the software application 110 will branch and follow one of two different logic paths.

Further, at 330, the method 300 may include assuming the user did not grant permission to use the geographic location features of the mobile device 105. If that is the case, the user is prompted to enter the property address they are interested in, to determine if a proximity-based property showing has been registered with the system for that location. The flow of this processing will pick up at location at 370 of the method 300.

Further, at 340, the method 300 may include assuming the user did grant permission to use the geographic location features of the mobile device 105. If that is the case, the device's location will be used to proceed.

Further, at 350, the method 300 may include identifying the geographic location of the mobile device 105. Further, the software application 110 may communicate to the server 140 over the Internet 130 by way of the API 160 running on the server 140. The API 160 may query the database 150 and determine if there is a proximity-based property showing defined for the user's present location.

Further, at 360, the method 300 may include loading property details into the mobile device 105. Further, the method 300 may include assuming a proximity-based property showing was found for the user's location. At that point, the beacon 120 information for the location may be returned to the software application 110.

Further, at 370, the method 300 may include continuing with the user being prompted by way of the software application 110 to start the real estate showing.

Further, at 380, the method 300 may include continuing with the user being given their initial real estate showing introduction by way of text, speech-to-text, recorded audio or video.

Further, at 390, the method 300 may include continuing with the user walking through the property. During this time the software application 110 is continually scanning the area, looking for the presence of the beacon signals broadcasting their identification.

Further, at 400, the method 300 may include continuing with determining if the software application 110 has detected the presence of the beacon 120 within range. Further, at 410, the method 300 may include assuming the mobile device 105 is not within range of the beacon 120. The logic will return at 390 of the method 300.

Further, at 420, the method 300 may include assuming the mobile device 105 is within range of the beacon 120. The software application 110 reads the identification of the beacon 120 and loads the appropriate point of interest information.

Further, at 430, the method 300 may include presenting the point of interest information by way of text, speech-to-text, recorded audio, or video. Logic returns at 390 of the method 300.

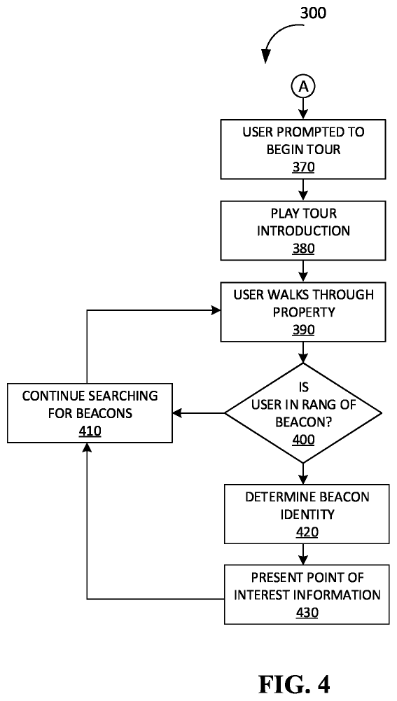

FIG. 4 is a continuation flowchart of FIG. 3.

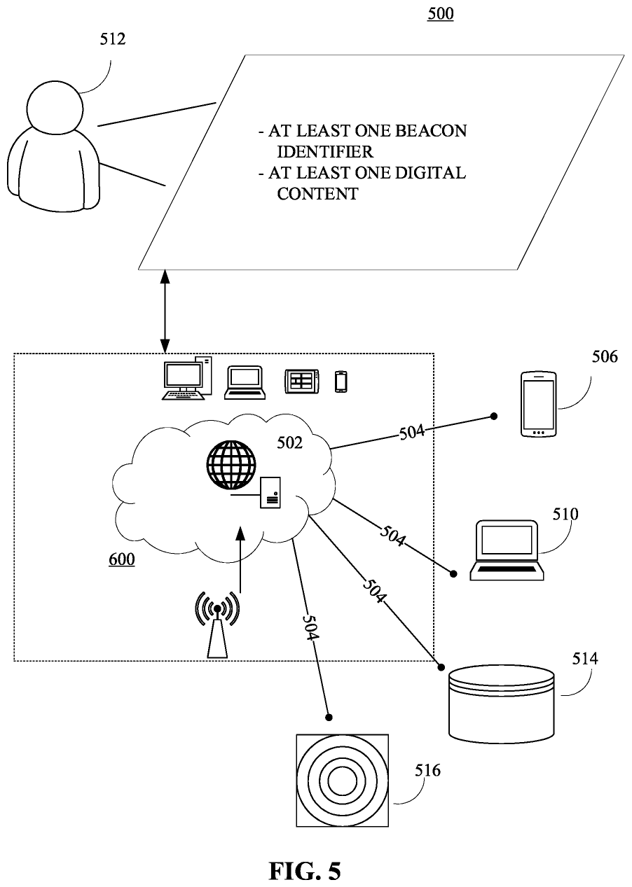

FIG. 5 is an illustration of an online platform 500 consistent with various embodiments of the present disclosure. By way of non-limiting example, the online platform 500 to enable facilitating provisioning of location-based information to a user device may be hosted on a centralized server 502, such as, for example, a cloud computing service. The centralized server 502 may communicate with other network entities, such as, for example, a mobile device 506 (such as a smartphone, a laptop, a tablet computer etc.), other electronic devices 510 (such as desktop computers, server computers etc.), databases 514, and sensors 516 over a communication network 504, such as, but not limited to, the Internet. Further, users of the online platform 500 may include relevant parties such as, but not limited to, end-users, administrators, service providers, service consumers and so on. Accordingly, in some instances, electronic devices operated by the one or more relevant parties may be in communication with the platform.

A user 512, such as the one or more relevant parties, may access online platform 500 through a web based software application or browser. The web based software application may be embodied as, for example, but not be limited to, a website, a web application, a desktop application, and a mobile application compatible with a computing device 600.

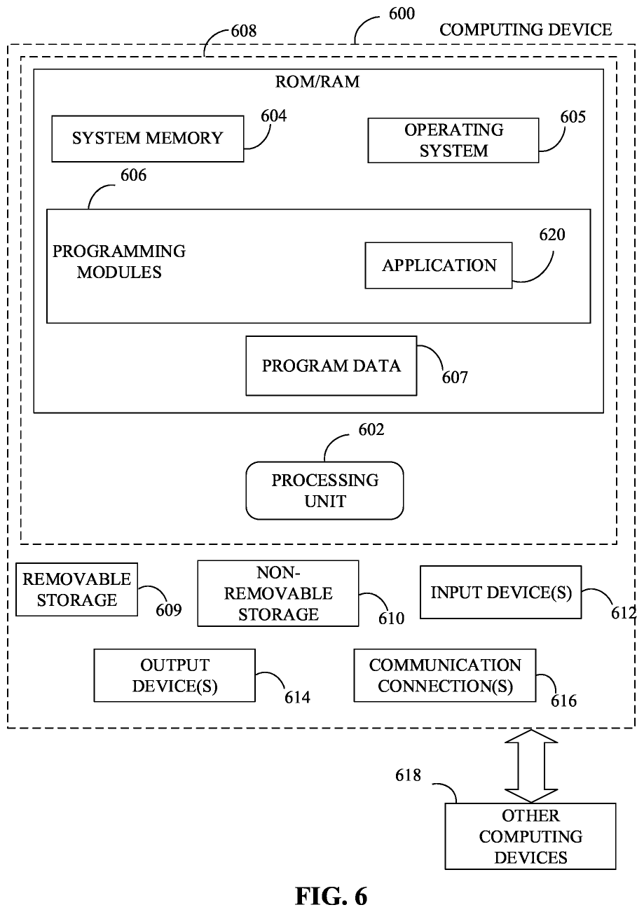

With reference to FIG. 6, a system consistent with an embodiment of the disclosure may include a computing device or cloud service, such as computing device 600. In a basic configuration, computing device 600 may include at least one processing unit 602 and a system memory 604. Depending on the configuration and type of computing device, system memory 604 may comprise, but is not limited to, volatile (e.g. random-access memory (RAM)), non-volatile (e.g. read-only memory (ROM)), flash memory, or any combination. System memory 604 may include operating system 605, one or more programming modules 606, and may include a program data 607. Operating system 605, for example, may be suitable for controlling computing device 600's operation. In one embodiment, programming modules 606 may include image-processing module, machine learning module. Furthermore, embodiments of the disclosure may be practiced in conjunction with a graphics library, other operating systems, or any other application program and is not limited to any particular application or system. This basic configuration is illustrated in FIG. 6 by those components within a dashed line 608.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and non-volatile, removable and non-removable media implemented in any method or technology for storage of information, such as computer-readable instructions, data structures, program modules, or other data. System memory 604, removable storage 609, and non-removable storage 610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a touch input device, a location sensor, a camera, a biometric sensor, etc. Output device(s) 614 such as a display, speakers, a printer, etc. may also be included. The aforementioned devices are examples and others may be used.

Computing device 600 may also contain a communication connection 616 that may allow device 600 to communicate with other computing devices 618, such as over a network in a distributed computing environment, for example, an intranet or the Internet. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 604, including operating system 605. While executing on processing unit 602, programming modules 606 (e.g., application 620 such as a media player) may perform processes including, for example, one or more stages of methods, algorithms, systems, applications, servers, databases as described above. The aforementioned process is an example, and processing unit 602 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

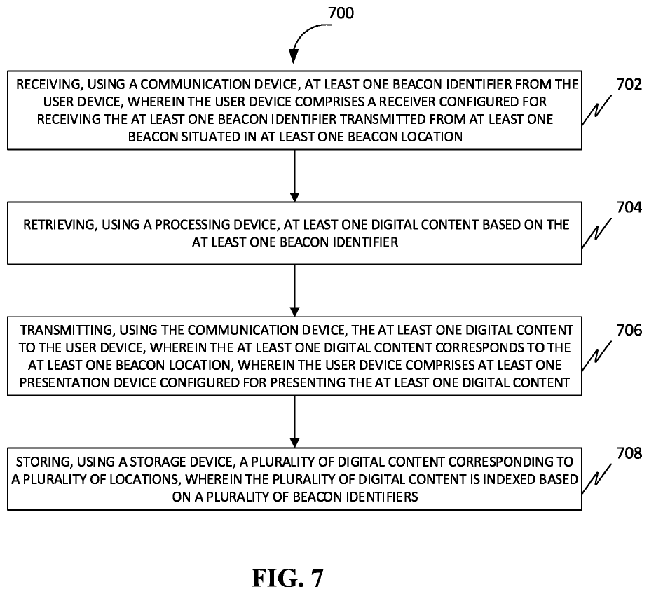

FIG. 7 is a flow chart of a method 700 for facilitating provisioning of location-based information to a user device, in accordance with some embodiments.

Further, the method 700 may include a step 702 of receiving, using a communication device, one or more beacon identifier from a user device. Further, the user device may include a receiver configured for receiving the one or more beacon identifier transmitted from one or more beacon situated in one or more beacon location. In some embodiments, the one or more digital content may include a digital content identifier corresponding to a digital media pre-loaded on the user device. Further, the user device may include a memory device configured for storing the digital media and retrieving the digital media based on the digital content identifier.

Further, the method 700 may include a step 704 of retrieving, using a processing device, one or more digital content based on the one or more beacon identifier.

Further, the method 700 may include a step 706 of transmitting, using the communication device, the one or more digital content to the user device. Further, the one or more digital content may corresponds to the one or more beacon location. Further, the user device may include one or more presentation device configured for presenting the one or more digital content.

Further, the method 700 may include a step 708 of storing, using a storage device, two or more digital content corresponding to two or more locations. Further, the two or more digital content is indexed based on two or more beacon identifiers.

In some embodiments, the location-based information may be associated with a real estate property. Further, the one or more beacon may be disposed within the real estate property.

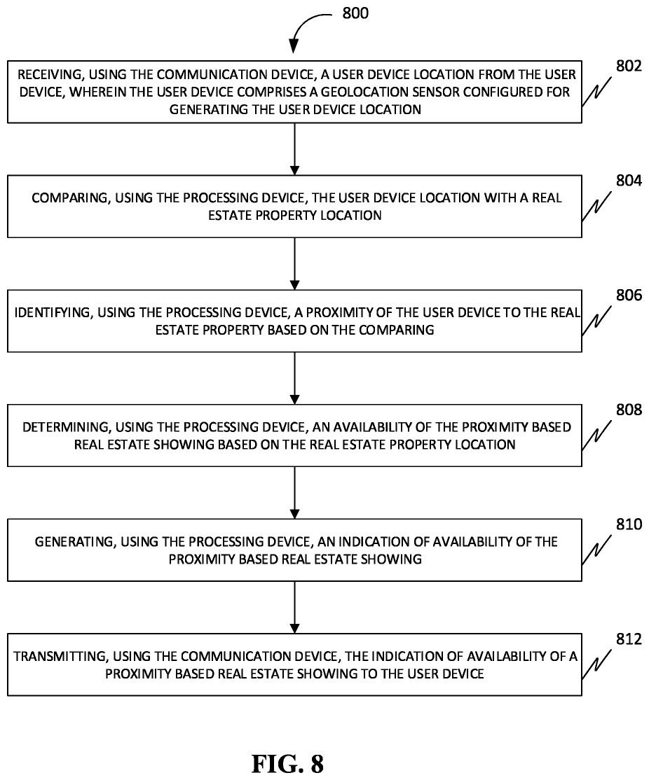

FIG. 8 is a flow chart of a method 800 for facilitating provisioning of location-based information to a user device in which the method 800 may include transmitting an indication of availability of a proximity based real estate showing to the user device, in accordance with some embodiments. Further, at 802, the method 800 may include receiving, using the communication device, a user device location from the user device. Further, the user device may include a geolocation sensor configured for generating the user device location. Further, at 804, the method 800 may include comparing, using the processing device, the user device location with a real estate property location. Further, at 806, the method 800 may include identifying, using the processing device, a proximity of the user device to the real estate property based on the comparing. Further, at 808, the method 800 may include determining, using the processing device, an availability of the proximity based real estate showing based on the real estate property location. Further, at 810, the method 800 may include generating, using the processing device, an indication of availability of the proximity based real estate showing. Further, at 812, the method 800 may include transmitting, using the communication device, the indication of availability of the proximity based real estate showing to the user device.

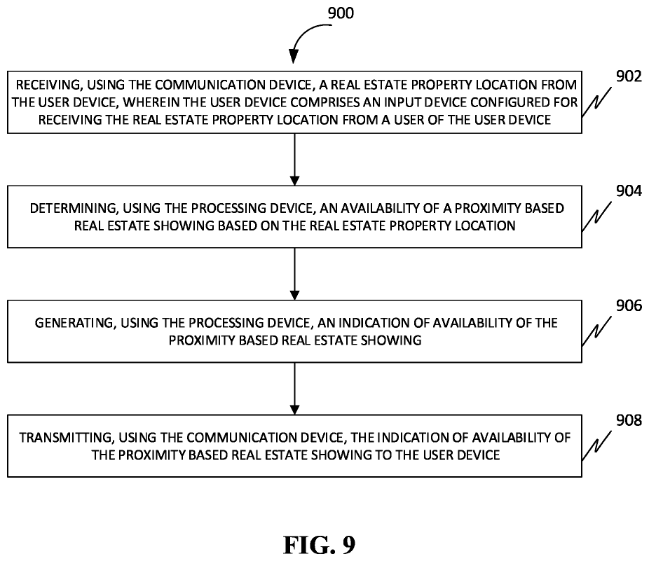

FIG. 9 is a flow chart of a method 900 for facilitating provisioning of location-based information to a user device in which the method 900 may include transmitting an indication of availability of the proximity based real estate showing to the user device, in accordance with some embodiments. Accordingly, the method 900 may include a step 902 of receiving, using the communication device, a real estate property location from the user device. Further, the user device may include an input device configured for receiving the real estate property location from a user of the user device. Further, the method 900 may include a step 904 of determining, using the processing device, an availability of a proximity based real estate showing based on the real estate property location. Further, the method 900 may include a step 906 of generating, using the processing device, an indication of availability of the proximity based real estate showing. Further, the method 900 may include a step 908 of transmitting, using the communication device, the indication of availability of the proximity based real estate showing to the user device.

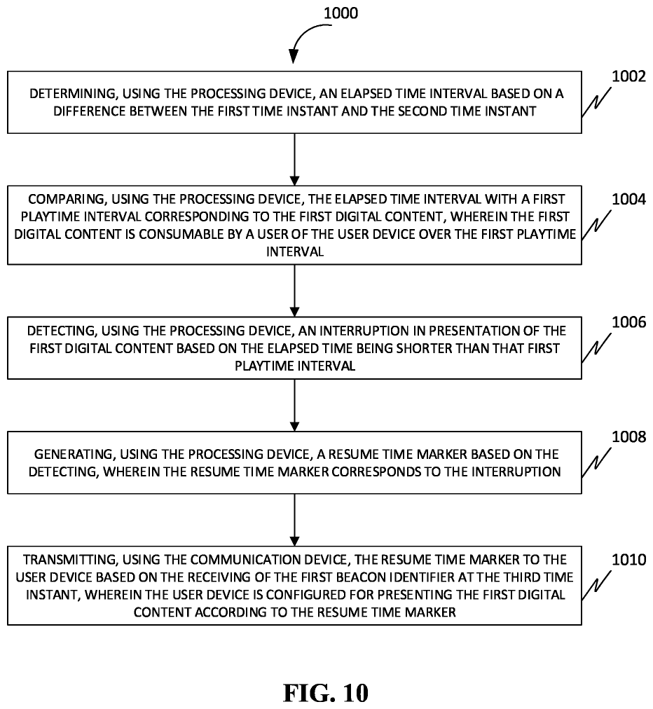

FIG. 10 is a flow chart of a method 1000 for facilitating provisioning of location-based information to a user device in which the method 1000 may include transmitting the resume time marker to the user device based on the receiving of the first beacon identifier at the third time instant, in accordance with some embodiments. Further, the one or more beacon identifier may include a first beacon identifier received at a first time instant, a second beacon identifier received at a second time instant and the first beacon identifier received at a third time instant the second time instant is later than the first time instant the third time instant is later than the second time instant the one or more digital content may include a first digital content corresponding to the first beacon identifier and a second digital content corresponding to the second beacon identifier. Further, the method 1000 may include a step 1002 of determining, using the processing device, an elapsed time interval based on a difference between the first time instant and the second time instant. Further, the method 1000 may include a step 1004 of comparing, using the processing device, the elapsed time interval with a first playtime interval corresponding to the first digital content. Further, the first digital content is consumable by a user of the user device over the first playtime interval. Further, the method 1000 may include a step 1006 of detecting, using the processing device, an interruption in presentation of the first digital content based on the elapsed time being shorter than that first playtime interval. Further, the method 1000 may include a step 1008 of generating, using the processing device, a resume time marker based on the detecting. Further, the resume time marker may corresponds to the interruption. Further, the method 1000 may include a step 1010 of transmitting, using the communication device, the resume time marker to the user device based on the receiving of the first beacon identifier at the third time instant. Further, the user device is configured for presenting the first digital content according to the resume time marker.

Further, in an instance, the elapsed time interval may include a time period (may be seconds, minutes, hours) between the first time instant and the second time instant. Further, the interruption may correspond to the user leaving the proximity of a particular beacon. Further, the resume time marker may include a time instant corresponding to the at least one digital content at the which the user left the proximity of the particular beacon.

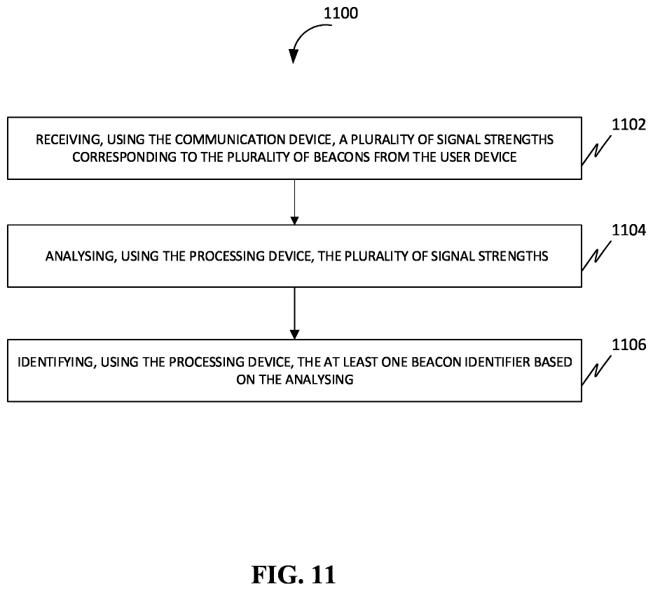

FIG. 11 is a flow chart of a method 1100 for facilitating provisioning of location-based information to a user device in which the method 1100 may include identifying the at least one beacon identifier based on the analyzing, in accordance with some embodiments. Further, the one or more beacon may include two or more beacons situated in two or more beacon locations. Further, the method 1100 may include a step 1102 of receiving, using the communication device, two or more signal strengths corresponding to the two or more beacons from the user device. Further, the method 1100 may include a step 1104 of analyzing, using the processing device, the plurality of signal strengths. Further, the method 1100 may include a step 1106 of identifying, using the processing device, the at least one beacon identifier based on the analyzing.

Further, in an instance, the plurality of signal strengths may include a first signal strength corresponding to a first beacon and a second signal strength corresponding to a second beacon. Further, the first signal strength may be greater than the second signal strength. Further, the processing device may be configured for identifying the first signal strength based on stronger signal strength and transmit the at least one digital content corresponding to the first beacon.

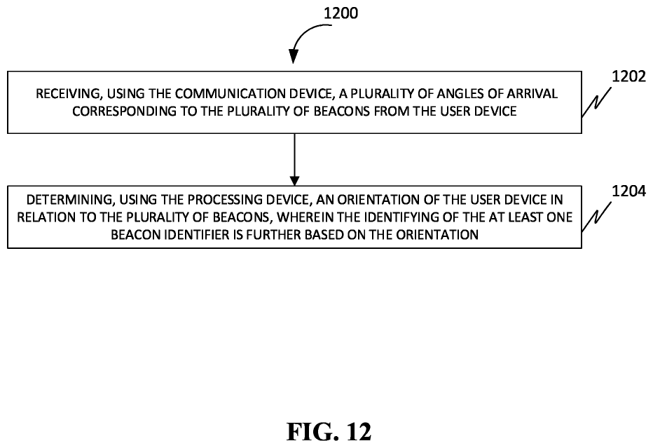

FIG. 12 is a flow chart of a method 1200 for facilitating provisioning of location-based information to a user device in which the method 1200 may include determining an orientation of the user device in relation to the two or more beacons, in accordance with some embodiments. Further, the method 1200 may include a step 1202 of receiving, using the communication device, two or more angles of arrival corresponding to the two or more beacons from the user device. Further, the method 1200 may include a step 1204 of determining, using the processing device, an orientation of the user device in relation to the two or more beacons. Further, the identifying of the one or more beacon identifier may be further based on the orientation.

Further, in an instance, the orientation of the user device may be one of a portrait orientation and a landscape orientation.

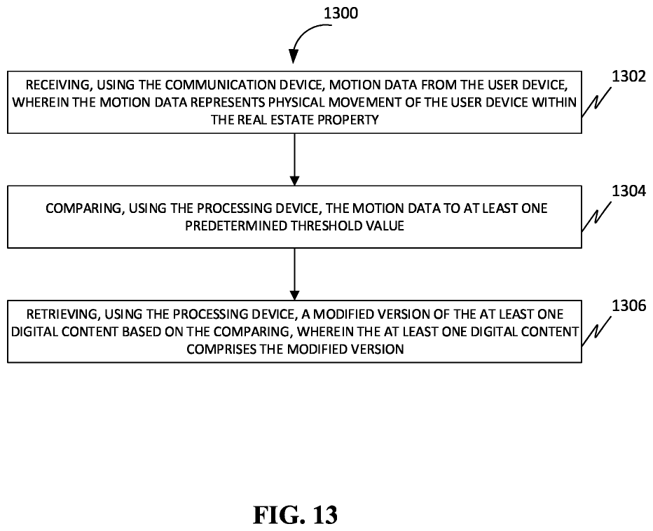

FIG. 13 is a flow chart of a method 1300 for facilitating provisioning of location-based information to a user device in which the method 1300 may include retrieving a modified version of the one or more digital content based on the comparing, in accordance with some embodiments. Further, the method 1300 may include a step 1302 of receiving, using the communication device, motion data from the user device. Further, the motion data represents physical movement of the user device within the real estate property. Further, the method 1300 may include a step 1304 of comparing, using the processing device, the motion data to one or more predetermined threshold value. Further, the method 1300 may include a step 1306 of retrieving, using the processing device, a modified version of the one or more digital content based on the comparing. Further, the one or more digital content may include the modified version.

Further, in an instance, the motion data may be associated with a pace at which the user may be moving within the premises of the real estate property. Further, the modified version may include an elaborated version and a summarized version of the at least one digital content. Further, the summarized version may include highlights of the at least one digital content. Further, the elaborated version may include details of the at least one digital content.

In some embodiments, the digital content may include textual content. Further, the method 1300 may include a step of generating, using the processing device, the modified version of the one or more digital content based on natural language processing (NLP) techniques.

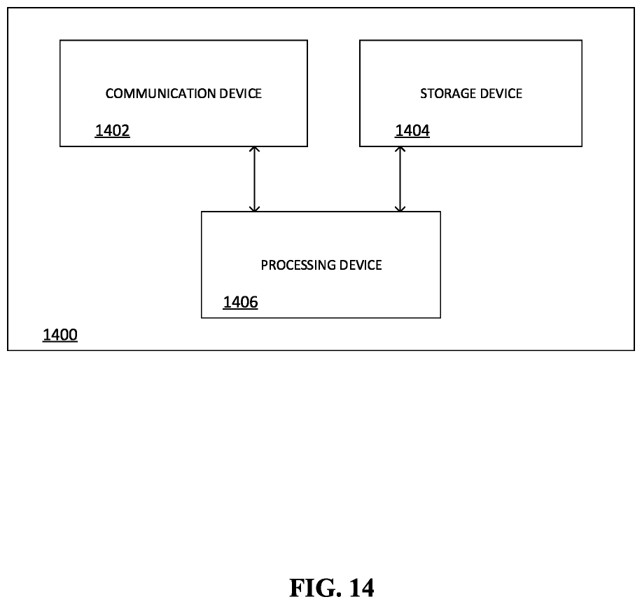

FIG. 14 is a block diagram of a system 1400 for facilitating provisioning of location-based information to a user device, in accordance with some embodiments. The system 1400 may include a communication device 1402, a storage device 1404, and a processing device 1406.

Further, the communication device 1402 may be configured for performing a step of receiving one or more beacon identifier from the user device. Further, the user device may include a receiver configured for receiving the one or more beacon identifier transmitted from one or more beacon situated in one or more beacon location.

Further, the communication device 1402 may be configured for performing a step of transmitting one or more digital content to the user device. Further, the one or more digital content may corresponds to the one or more beacon location. Further, the user device may include one or more presentation device configured for presenting the one or more digital content.

Further, the storage device 1404 may be configured for performing a step of storing two or more digital content corresponding to two or more locations. Further, the two or more digital content is indexed based on two or more beacon identifiers.

The processing device 1406 may be communicatively coupled to the communication device 1402 and the storage device 1404.

Further, the processing device 1406 may be configured for performing a step of retrieving the one or more digital content based on the one or more beacon identifier.

In some embodiments, the one or more digital content may include a digital content identifier corresponding to a digital media pre-loaded on the user device, the user device may include a memory device configured for storing the digital media and retrieving the digital media based on the digital content identifier.

In some embodiments, the location-based information may be associated with a real estate property, the one or more beacon may be disposed within the real estate property.

In some embodiments, the communication device 1402 may be configured for performing a step of receiving a user device location from the user device. Further, the user device may include a geolocation sensor configured for generating the user device location. Further, the communication device 1402 may be configured for performing a step of transmitting an indication of availability of a proximity based real estate showing to the user device. Further, the processing device 1406 may be configured for performing a step of comparing the user device location with a real estate property location. Further, the processing device 1406 may be configured for performing a step of identifying a proximity of the user device to the real estate property based on the comparing. Further, the processing device 1406 may be configured for performing a step of determining an availability of the proximity based real estate showing based on the real estate property location. Further, the processing device 1406 may be configured for performing a step of generating the indication of availability of the proximity based real estate showing.

In some embodiments, the communication device 1402 may be configured for performing a step of receiving a real estate property location from the user device. Further, the user device may include an input device configured for receiving the real estate property location from a user of the user device. Further, the communication device 1402 may be configured for performing a step of transmitting an indication of availability of a proximity based real estate showing to the user device. Further, the processing device 1406 may be configured for performing a step of determining an availability of the proximity based real estate showing based on the real estate property location. Further, the processing device 1406 may be configured for performing a step of generating the indication of availability of the proximity based real estate showing.

In some embodiments, the one or more beacon identifier may include a first beacon identifier received at a first time instant, a second beacon identifier received at a second time instant and the first beacon identifier received at a third time instant. Further, the second time instant may be later than the first time instant. Further, the third time instant may be later than the second time instant. Further, the one or more digital content may include a first digital content corresponding to the first beacon identifier and a second digital content corresponding to the second beacon identifier, the processing device 1406 may be configured for performing a step of determining an elapsed time interval based on a difference between the first time instant and the second time instant. Further, the processing device 1406 may be configured for performing a step of comparing the elapsed time interval with a first playtime interval corresponding to the first digital content. Further, the first digital content may be consumable by a user of the user device over the first playtime interval. Further, the processing device 1406 may be configured for performing a step of detecting an interruption in the presentation of the first digital content based on the elapsed time being shorter than that first playtime interval. Further, the processing device 1406 may be configured for performing a step of generating a resume time marker based on the detecting. Further, the resume time marker may correspond to the interruption. Further, the communication device 1402 may be configured for performing a step of transmitting the resume time marker to the user device based on the receiving of the first beacon identifier at the third time instant. Further, the user device may be configured for presenting the first digital content according to the resume time marker.

In some embodiments, the one or more beacon may include two or more beacons situated in two or more beacon locations, the communication device 1402 may be configured for performing a step of receiving two or more signal strengths corresponding to the two or more beacons from the user device. Further, the processing device 1406 may be configured for performing a step of analyzing the two or more signal strengths. Further, the processing device 1406 may be configured for performing a step of identifying the one or more beacon identifier based on the analyzing.

In some embodiments, the communication device 1402 may be configured for performing a step of receiving two or more angles of arrival corresponding to the two or more beacons from the user device. Further, the processing device 1406 may be configured for performing a step of determining an orientation of the user device in relation to the two or more beacons. Further, the identifying of the one or more beacon identifier may be based on the orientation.

In some embodiments, the communication device 1402 may be configured for performing a step of receiving motion data from the user device. Further, the motion data represents physical movement of the user device within the real estate property. Further, the processing device 1406 may be configured for performing a step of comparing the motion data to one or more predetermined threshold value. Further, the processing device 1406 may be configured for performing a step of retrieving a modified version of the one or more digital content based on the comparing. Further, the one or more digital content may include the modified version.

In some embodiments, the digital content may include textual content. Further, the processing device 1406 may be configured for performing a step of generating the modified version of the one or more digital content based on natural language processing (NLP) techniques.

### Aspects

1. A server for use in a system including a mobile device, the server comprising: a memory storing a beacon database and a point of interest database having information to be conveyed to a user being associated with one of a plurality of beacons stored in the beacon database; and a processor configured to:
   a. receive, from the mobile device, a message transmitted by a beacon of the plurality of beacons to the mobile device when the mobile device being carried by a user is at a location; determine a beacon identity of the beacon using the message; obtain a point of interest-based on the beacon identity;
   b. provide the point of interest data for the user to the mobile device; repeat this process for any number of beacons at a particular location
2. The server of aspect 1, wherein the mobile device includes a display, and wherein the processor provides a point of interest information by playing said information on the display of the mobile device;
3. The server of aspect 1, wherein the first beacon is located in a defined geographic location, and wherein to obtain the first point of interest information for that location the processor is configured to:
   a. determine the defined geographic location using the first beacon identity of the first beacon;
   b. and obtain point of interest information based on the defined geographic location;
4. The server of aspect 1, wherein the defined geographic location includes at least one of a room in a house, apartment, condominium, office space, or other business-building;
5. The server of aspect 1, wherein before receiving the first message, the processor is further configured to:
   a. receive a plurality of beacon identities including the first beacon identity; and associate each of the plurality of beacon identities including the first beacon identity with one of the plurality of beacons including the first beacon.
6. The server of aspect 1, wherein each of the plurality of beacons includes a Bluetooth device, and wherein the first message is received by the mobile device from the first beacon using the Bluetooth device;
7. A method for use by a server for use in a system including a mobile device, the server having a memory storing a beacon database and a point of interest database, the point of interest database having text, text-to-speech, recorded audio, or recorded video associated with one of a plurality of beacons stored in the beacon database, the method comprising:
   a. receiving, from the mobile device, a message transmitted by a beacon of the plurality of beacons to the mobile device when the mobile device being carried by a user is at a location; determining a beacon identity of the beacon using the message;
8. The method of aspect 7, wherein the mobile device includes a display, and wherein providing the point of interest information plays the point of interest information on the display of the mobile device;
9. A device comprising:
   a. a memory storing a beacon database and a point of interest database, the point of interest database each entry being associated with one of a plurality of beacons stored in the beacon database; and;
   b. a processor configured to:
      i. receive messages transmitted from a beacon of the plurality of beacons; determine an object identity associated with the beacon using the message; obtain point of interest for the associated beacon; play the point of interest recorded presentation in whatever form; determine as user proceeds through location additional object identities associated with beacons broadcasting messages; repeat process for any beacons found.
10. The device of aspect 9, wherein the device is one of a mobile device and a server, and wherein the multiple beacons may be configured per location.

Although the present disclosure has been explained in relation to its preferred embodiment, it is to be understood that many other possible modifications and variations can be made without departing from the spirit and scope of the disclosure.

We claim:

1. A method for facilitating provisioning of location-based information to a user device, the method comprising:
receiving, using a communication device, at least one beacon identifier from the user device, wherein the user device comprises a receiver configured for receiving the at least one beacon identifier transmitted from at least one beacon situated in at least one beacon location;
retrieving, using a processing device, at least one digital content based on the at least one beacon identifier;
transmitting, using the communication device, the at least one digital content to the user device, wherein the at least one digital content corresponds to the at least one beacon location, wherein the user device comprises at least one presentation device configured for presenting the at least one digital content; and
storing, using a storage device, a plurality of digital content corresponding to a plurality of locations, wherein the plurality of digital content is indexed based on a plurality of beacon identifiers.

2. The method of claim 1, wherein the location-based information is associated with a real estate property, wherein the at least one beacon is disposed within the real estate property.

3. The method of claim 2 further comprising:
receiving, using the communication device, a user device location from the user device, wherein the user device comprises a geolocation sensor configured for generating the user device location;
comparing, using the processing device, the user device location with a real estate property location;
identifying, using the processing device, a proximity of the user device to the real estate property based on the comparing;
determining, using the processing device, an availability of the proximity based real estate showing based on the real estate property location;
generating, using the processing device, an indication of availability of the proximity based real estate showing; and
transmitting, using the communication device, the indication of availability of the proximity based real estate showing to the user device.

4. The method of claim 2 further comprising:
receiving, using the communication device, a real estate property location from the user device, wherein the user device comprises an input device configured for receiving the real estate property location from a user of the user device;
determining, using the processing device, an availability of a proximity based real estate showing based on the real estate property location;
generating, using the processing device, an indication of availability of the proximity based real estate showing; and
transmitting, using the communication device, the indication of availability of the proximity based real estate showing to the user device.

5. The method of claim 1, wherein the at least one digital content comprises a digital content identifier corresponding to a digital media pre-loaded on the user device, wherein the user device comprises a memory device configured for storing the digital media and retrieving the digital media based on the digital content identifier.

6. The method of claim 1, wherein the at least one beacon identifier comprises a first beacon identifier received at a first time instant, a second beacon identifier received at a second time instant and the first beacon identifier received at a third time instant, wherein the second time instant is later than the first time instant, wherein the third time instant is later than the second time instant, wherein the at least one digital content comprises a first digital content corresponding to the first beacon identifier and a second digital content corresponding to the second beacon identifier, wherein the method further comprises:
determining, using the processing device, an elapsed time interval based on a difference between the first time instant and the second time instant;
comparing, using the processing device, the elapsed time interval with a first playtime interval corresponding to the first digital content, wherein the first digital content is consumable by a user of the user device over the first playtime interval;
detecting, using the processing device, an interruption in presentation of the first digital content based on the elapsed time being shorter than that first playtime interval;
generating, using the processing device, a resume time marker based on the detecting, wherein the resume time marker corresponds to the interruption; and
transmitting, using the communication device, the resume time marker to the user device based on the receiving of the first beacon identifier at the third time instant, wherein the user device is configured for presenting the first digital content according to the resume time marker.

7. The method of claim 2, wherein the at least one beacon comprises a plurality of beacons situated in a plurality of beacon locations, wherein the method further comprises:
receiving, using the communication device, a plurality of signal strengths corresponding to the plurality of beacons;
analyzing, using the processing device, the plurality of signal strengths; and
identifying, using the processing device, the at least one beacon identifier based on the analyzing.

8. The method of claim 7 further comprising:
receiving, using the communication device, a plurality of angles of arrival corresponding to the plurality of beacons; and
determining, using the processing device, an orientation of the user device in relation to the plurality of beacons, wherein the identifying of the at least one beacon identifier is further based on the orientation.

9. The method of claim 2 further comprising:
receiving, using the communication device, motion data from the user device, wherein the motion data represents physical movement of the user device within the real estate property;
comparing, using the processing device, the motion data to at least one predetermined threshold value; and
retrieving, using the processing device, a modified version of the at least one digital content based on the comparing, wherein the at least one digital content comprises the modified version.

10. The method of claim 9, wherein the digital content comprises textual content, wherein the method further comprises generating, using the processing device, the modified version of the at least one digital content based on natural language processing (NLP) techniques.

11. A system for facilitating provisioning of location-based information to a user device, the system comprising:
a communication device configured for:
receiving at least one beacon identifier from the user device, wherein the user device comprises a receiver configured for receiving the at least one beacon identifier transmitted from at least one beacon situated in at least one beacon location; and
transmitting at least one digital content to the user device, wherein the at least one digital content corresponds to the at least one beacon location, wherein the user device comprises at least one presentation device configured for presenting the at least one digital content;
a storage device configured for storing a plurality of digital content corresponding to a plurality of locations, wherein the plurality of digital content is indexed based on a plurality of beacon identifiers; and
a processing device communicatively coupled to the communication device and the storage device, wherein the processing device is configured for retrieving the at least one digital content based on the at least one beacon identifier.

12. The system of claim 11, wherein the location-based information is associated with a real estate property, wherein the at least one beacon is disposed within the real estate property.

13. The system of claim 12, wherein the communication device is further configured for:
receiving a user device location from the user device, wherein the user device comprises a geolocation sensor configured for generating the user device location; and
transmitting an indication of availability of a proximity based real estate showing to the user device, wherein the processing device is further configured for:
comparing the user device location with a real estate property location;
identifying a proximity of the user device to the real estate property based on the comparing;
determining an availability of the proximity based real estate showing based on the real estate property location; and
generating the indication of availability of the proximity based real estate showing.

14. The system of claim 12, wherein the communication device is further configured for:
receiving a real estate property location from the user device, wherein the user device comprises an input device configured for receiving the real estate property location from a user of the user device; and
transmitting an indication of availability of a proximity based real estate showing to the user device, wherein the processing device is further configured for:
determining an availability of the proximity based real estate showing based on the real estate property location; and
generating the indication of availability of the proximity based real estate showing.

15. The system of claim 11, wherein the at least one digital content comprises a digital content identifier corresponding to a digital media pre-loaded on the user device, wherein the user device comprises a memory device configured for storing the digital media and retrieving the digital media based on the digital content identifier.

16. The system of claim 11, wherein the at least one beacon identifier comprises a first beacon identifier received at a first time instant, a second beacon identifier received at a second time instant and the first beacon identifier received at a third time instant, wherein the second time instant is later than the first time instant, wherein the third time instant is later than the second time instant, wherein the at least one digital content comprises a first digital content corresponding to the first beacon identifier and a second digital content corresponding to the second beacon identifier, wherein the processing device is configured for:
determining an elapsed time interval based on a difference between the first time instant and the second time instant;
comparing the elapsed time interval with a first playtime interval corresponding to the first digital content, wherein the first digital content is consumable by a user of the user device over the first playtime interval;
detecting an interruption in presentation of the first digital content based on the elapsed time being shorter than that first playtime interval; and
generating a resume time marker based on the detecting, wherein the resume time marker corresponds to the interruption, wherein the communication device is further configured for transmitting the resume time marker to the user device based on the receiving of the first beacon identifier at the third time instant, wherein the user device is configured for presenting the first digital content according to the resume time marker.

17. The system of claim 12, wherein the at least one beacon comprises a plurality of beacons situated in a plurality of beacon locations, wherein the communication device is further configured for receiving a plurality of signal strengths corresponding to the plurality of beacons, wherein the processing device is further configured for:
analyzing the plurality of signal strengths; and
identifying the at least one beacon identifier based on the analyzing.

18. The system of claim 17, wherein the communication device is further configured for receiving a plurality of angles of arrival corresponding to the plurality of beacons, wherein the processing device is further configured for determining an orientation of the user device in relation to the plurality of beacons, wherein the identifying of the at least one beacon identifier is further based on the orientation.

19. The system of claim 12, wherein the communication device is further configured for receiving motion data from the user device, wherein the motion data represents physical movement of the user device within the real estate property, wherein the processing device is further configured for:
comparing the motion data to at least one predetermined threshold value; and
retrieving a modified version of the at least one digital content based on the comparing, wherein the at least one digital content comprises the modified version.

20. The system of claim 19, wherein the digital content comprises textual content, wherein the processing device is further configured for generating the modified version of the at least one digital content based on natural language processing (NLP) techniques.
